(19) United States
(12) Patent Application Publication
(10) Pub. No.: US 2008/0239588 A1
(43) Pub. Date: Oct. 2, 2008

(54) Magneto-resistance effect element, magnetic head, and magnetic recording/reproducing device

(75) Inventors: Masahiro Takashita, Yokohama-shi (JP); Tomomi Funayama, Tokorozawa-shi (JP); Masayuki Takagishi, Tokyo (JP); Hitoshi Iwasaki, Yokosuka-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/076,164

(22) Filed: Mar. 14, 2008

(30) Foreign Application Priority Data
Mar. 26, 2007 (JP) P2007-078894

(51) Int. Cl. G11B 5/33

(52) U.S. Cl. 360/324.1

(57) ABSTRACT

A magneto-resistance effect element includes a magneto-resistance effect film comprised of a free magnetization layer, a fixed magnetization layer and an intermediate layer disposed between the free magnetization layer and the fixed magnetization layer; a magnetic coupling layer which is disposed on one main surface of the fixed magnetization layer; a ferromagnetic layer which is disposed on one main surface of the magnetic coupling layer; an antiferromagnetic layer which is disposed on one main surface of the ferromagnetic layer; a magnetic domain controlling film for applying a biasing magnetic field to the free magnetization layer; and a pair of electrodes for flowing a current in the magneto-resistance effect film; wherein an asymmetry is set positive and an element resistance RA is set to 1.5 Ωμm² or less in the direction from the free magnetization layer to the fixed magnetization layer.

### CROSS-REFERENCE TO RELATED APPLICATIONS

This application is based upon and claims the benefit of priority from the prior Japanese Patent Application No. 2007-078894, filed on Mar. 26, 2007; the entire contents of which are incorporated herein by reference.

### BACKGROUND OF THE INVENTION

1. Field of the Invention

The present invention relates to a magneto-resistance effect element which is configured such that a current is flowed in the direction perpendicular to the film surface thereof. The present invention also relates to a magnetic head and a magnetic recording/reproducing device which utilize the magneto-resistance effect element according to the present invention.

2. Description of the Related Art

Recently, a GMR head with a GMR element exhibiting GMR effect (Giant Magnetoresistive effect) is widely available in reproducing information recorded in a magnetic recording medium of a magnetic recording/reproducing device such as a hard disk drive.

A spin valve type GMR element is composed of a multilayerd structure including a fixed magnetization layer, a free magnetization layer and an intermediate layer which is disposed between the fixed magnetization layer and the free magnetization layer. The fixed magnetization layer contains a magnetic film of which the magnetization is substantially fixed in one direction. The magnetization direction of the magnetic film is changed in accordance with an external magnetic field (e.g., a signal magnetic field from the magnetic recording medium which is aligned in a direction parallel to or antiparallel to the magnetization of the fixed magnetization layer).

Moreover, a longitudinal biasing magnetic field is applied to the free magnetization layer by means of a longitudinal biasing mechanism (e.g., made of a magnetic domain controlling film of CoPt alloy or CoCrPt alloy) so that the longitudinal biasing magnetic field can be substantially parallel to the film surface of the fixed magnetization layer and substantially perpendicular to the magnetization of the fixed magnetization layer. In this case, the magnetization of the fixed magnetization layer is almost orthogonal to the magnetization of the free magnetization layer under no signal magnetic field so that Barkhausen noise can be prevented. The GMR effect can be generated by the change in relative angle between the fixed magnetization layer and the free magnetization layer.

The GMR element can be classified into a CIP (Current In Plane)-GMR element, a TMR (tunnel MR) element and a CPP (Current Perpendicular to Plane)-GMR element. In the CIP GMR element, a sense current is flowed parallel to the film surface of the multilayerd film so as to detect the magneto-resistance effect (MR effect). In the TMR element or the CPP-GMR element, a sense current is flowed perpendicular to the film surface of the multilayered film so as to detect the MR effect.

The CPP-GMR element can exhibit a larger output than the CIP-GMR element even though the track width of the GMR head is narrowed so as to be able to be applied for high density recording. In the CIP-GMR element, since the sense current is flowed parallel to the film surface of the multilayered structure, the resistance change AR becomes small because the area contributing to the GMR effect becomes small as the track width of the magnetic recording medium is narrowed. In the CPP-GMR element, in contrast, since the sense current is flowed perpendicular to the film surface of the multilayered film, the resistance change AR does not become small even though the track width of the magnetic recording medium is narrowed.

Herein, the biasing point-controlling technique in the CIP-GMR element is disclosed in Reference 1.

The TMR element includes an intermediate layer made of oxide such as Al₂O₃ or MgO. Generally, the TMR element has an advantage of the MR effect of the TMR element being much larger than the MR effect of the CPP-GMR element. On the contrary, since the TMR element has the oxide intermediate layer as an insulator, the TMR element is likely to exhibit some noises such as shot noise. Moreover, since the resistance of the TMR element is larger, the matching for a preamplifier of the TMR element is deteriorated.

In this point of view, such a CPP element as containing an oxide layer with current paths (NOL (nano-oxide layer)) in the intermediate layer along the thickness direction thereof is proposed (refer to Reference 2). In the proposed CPP element, the element resistance and the MR variation ratio can be enhanced by the current-confined path (CCP) effect. Hereinafter, the proposed CPP element will be called as a “CCP-CPP element”.

The size of the magnetic head becomes small in the track width direction and the height direction as the recording density becomes high. The track width and height length of a magnetic recording/reproducing device such as a hard disk are set to 100 nm or less, recently.

In the use of the CPP-GMR element for the magnetic head, STIN (Spin transfer induced noise) may occur due to the spin transfer or CIMS (current induced magnetization switching). Under the generation of STIN, the direction of the magnetization of the free magnetization layer is substantially changed so that some noises which depends on the direction of the magnetic field generated from the magnetic recording medium occur. The STIN is likely to be generated in a magnetic element with a track width of 100 nm or less and a height length of 100 nm or less because the magnetic domain is likely to be single and is not subject to the edge domain.

FIG. 1 relates to the HDD bit error rate (BER) on the biasing voltage (which is represented by the multiplication of the sense current and the resistance of the magnetic head) and the signal waveforms when the sense current is flowed to the fixed magnetization layer from the free magnetization layer. The signal waveform in the bottom of FIG. 1 shows the state where no STIN is observed and the low BER is maintained under the condition of large biasing voltage. The signal waveform in the top of FIG. 1 shows the state where the BER is deteriorated by the STIN. In this case, the signal waveform in the negative region, which means the magnetization of the free magnetization layer is almost parallel to the magnetization of the fixed magnetization layer, shows the normal state and the signal waveform in the positive region, which means the magnetization of the free magnetization layer is almost antiparallel to the magnetization of the fixed magnetization layer, shows the distorted state. The relation in direction between the sense current and the magnetization is correlated with the direction of the STIN being likely to occur.

[Reference 1] JP-A 2000-137906 (KOKAI)

[Reference 2] JP-A 2002-208744 (KOKAI)

### BRIEF SUMMARY OF THE INVENTION

An aspect of the present invention relates to a CPP-GMR element, including: a CPP-GMR film comprised of a free magnetization layer with a first magnetic film of which a magnetization is changed in accordance with an external magnetic field, a fixed magnetization layer with a second magnetic film of which a magnetization is fixed in one direction and an intermediate layer disposed between the free magnetization layer and the fixed magnetization layer; a magnetic coupling layer which is disposed on one main surface of the fixed magnetization layer opposite to the other main surface of the fixed magnetization layer adjacent to the intermediate layer; a ferromagnetic layer which is disposed on one main surface of the magnetic coupling layer opposite to the other main surface of the magnetic coupling layer adjacent to the fixed magnetization layer; an antiferromagnetic layer which is disposed on one main surface of the ferromagnetic layer opposite to the other main surface of the ferromagnetic layer adjacent to the magnetic coupling layer; a magnetic domain controlling film for applying a biasing magnetic field to the free magnetization layer so that a direction of the biasing magnetic field can be parallel to a film surface of the magneto-resistance effect film and perpendicular to a magnetization direction of the fixed magnetization layer; and a pair of electrodes for flowing a current in the magneto-resistance effect film along a direction from the free magnetization layer to the fixed magnetization layer; wherein an asymmetry is set positive; wherein an element resistance RA is set to 1.5 Ωμm² or less.

### BRIEF DESCRIPTION OF THE SEVERAL VIEWS OF THE DRAWINGS

FIG. 1 relates to the HDD bit error rate (BER) on the biasing voltage in a magnetic reproducing device when a sense current is flowed to the fixed magnetization layer from the free magnetization layer.

FIG. 2 is a cross sectional view showing the structure of a magneto-resistance effect element according to an embodiment.

FIG. 3 is a schematic view showing the directions of the magnetizations of the magneto-resistance effect element shown in FIG. 1, as viewed from the top thereof.

FIG. 4 is a cross sectional view showing the structure of a magneto-resistance effect element according to another embodiment.

FIG. 5 is a schematic view showing the directions of the magnetizations of the magneto-resistance effect shown in FIG. 4, as viewed from the top thereof.

FIG. 6 is a schematic view for explaining the biasing point of a magneto-resistance effect element.

FIG. 7 is a schematic view for explaining the asymmetry in output of a magneto-resistance effect element.

FIG. 8 is a schematic view showing the relation between the direction of a current and the direction of the magnetic field generated from the current in a CIP-GMR element.

FIG. 9 is a schematic view showing the relation between the direction of a current and the direction of the magnetic field generated from the current in a CPP-GMR element.

FIG. 10 is an explanatory view for obtaining the interlayer coupling magnetic field “Hin” in the magneto-resistance effect element according to another embodiment.

FIG. 11 is a graph showing the change in resistance on the change in signal magnetic field in the magneto-resistance effect element according to the embodiment.

FIG. 12 is an explanatory view of medium signal reproducing efficiency EF_{M}.

FIG. 13 is a flowchart for manufacturing the magneto-resistance effect element according to the embodiment.

FIG. 14 is a cross sectional view showing the magneto-resistance effect element to be manufactured according to the process shown in FIG. 13.

FIG. 15 is a cross sectional view showing the magneto-resistance effect element to be manufactured according to the process shown in FIG. 13.

FIG. 16 is a perspective view showing a magnetic recording/reproducing device according to an embodiment.

FIG. 17 is an enlarged perspective view showing a magnetic head assembly according to an embodiment.

FIG. 18 is a graph showing the relation between the asymmetry and the biasing voltage in the magnetic recording/reproducing device according to the embodiment.

FIG. 19 is a graph showing the relation between the BER and the asymmetry in the magnetic recording/reproducing device according to the embodiment.

FIG. 20 is a graph showing the relation between the asymmetry and the TAA (head output) in the magnetic recording/reproducing device according to the embodiment.

### DETAILED DESCRIPTION OF THE INVENTION

Hereinafter, the present invention will be described in detail with reference to the drawings.

If the (sense) current is flowed to the fixed magnetization layer from the free magnetization layer, the asymmetry is set positive and the element resistance RA is set to 1.5 Ωμm² or less, the STIN in the magneto-resistance effect element can be reduced.

The asymmetry is defined as physical parameter mainly for the signal waveform obtained from a device containing the magneto-resistance effect element therein, and will be described in detail hereinafter. The element resistance RA is defined as a resistance per unit area when the current is flowed to the fixed magnetization layer from the free magnetization layer.

In an embodiment, in the magneto-resistance effect film, an interlayer coupling magnetic field between the fixed magnetization layer and the free magnetization layer is set within a range of 30 to 100 Oe. In this case, the STIN can be reduced effectively and the asymmetry can be set positive.

In another embodiment, a medium signal reproducing efficiency of the magneto-resistance effect element is set less than 15%. In this case, the STIN can be reduced effectively.

The medium signal reproducing efficiency can be obtained by dividing the resistance change ratio ΔR_{B} obtained on a signal from a magnetic recording medium by the maximum resistance change ΔR₀ of the magneto-resistance effect element, and thus, can be defined as ΔR_{B}/ΔR₀. The medium signal reproducing efficiency will be described in detail hereinafter.

The interlayer coupling magnetic field Hin can be easily adjusted by controlling the thickness of the intermediate layer disposed between the fixed magnetization layer and the free magnetization layer. Then, the medium signal reproducing efficiency can be easily adjusted by controlling the distance between the free magnetization layer and the magnetic domain controlling film.

In the aspect according to the present invention, when the intermediate layer exhibits metallic conduction, the magneto-resistance effect element constitutes a GMR element. When the intermediate layer is made of oxide, the magneto-resistance effect element constitutes a TMR element. When the intermediate layer is made of an oxide matrix and conductors formed in the oxide matrix so that the conductors are electrically connected with the free magnetization layer and the fixed magnetization layer throughout the oxide matrix, the magneto-resistance effect element constitutes a CCP-CPP element.

### (Structure of Magneto-Resistance Effect Element)

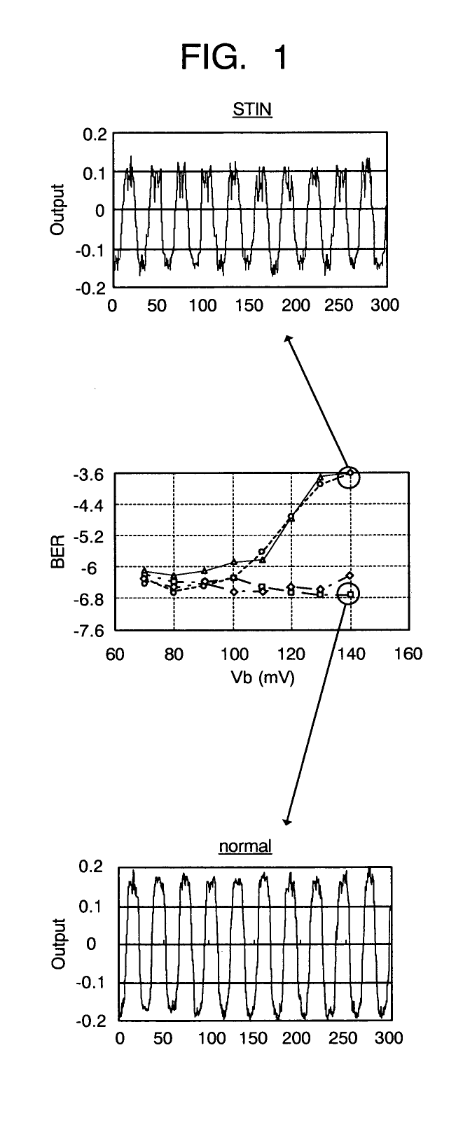

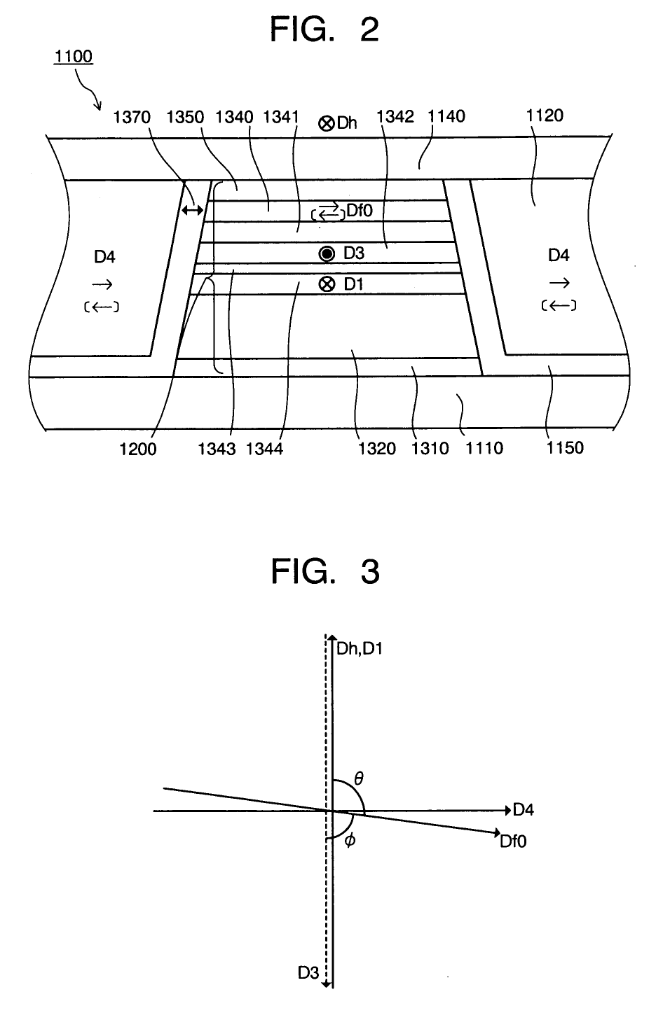

FIG. 2 is a cross sectional view showing the structure of a magneto-resistance effect element according to an embodiment, as viewed from the ABS thereof to be faced with a magnetic recording medium to be read out in information. FIG. 3 is a schematic view showing the directions of the magnetizations of the magneto-resistance effect element shown in FIG. 1, as viewed from the top thereof.

The magneto-resistance effect element 1100 shown in FIG. 1 includes a spin valve film 1200, a pair of magnetic domain controlling films 1120, a bottom shielding layer 1110, and a top shielding layer 1140. The bottom shielding layer 1110 and the top shielding layer 1140 are disposed so as to sandwich the magnetic domain controlling layers 1110 and the spin valve film 1200 along the stacking direction thereof. The bottom shielding layer 1110 and the top shielding layer 1140 are made of NiFe alloy and the like so as to function as a bottom electrode and a top electrode, respectively.

A sense current is flowed between the bottom shielding layer (bottom electrode) 1110 and the top shielding layer (top electrode) 1140 so that the GMR element 1100 can constitute a CPP-GMR element. In this embodiment, it is required that the sense current is flowed to the bottom shielding layer (bottom electrode) 1110 from the top shielding layer (top electrode) 1140, namely, to the fixed magnetization layer 1342 from the free magnetization layer 1340.

The spin valve film 1200 is configured as a multilayered film made of a underlayer 1310, an antiferromagnetic layer 1320, a ferromagnetic layer 1344, a magnetic coupling layer 1343, the fixed magnetization layer 1342, an intermediate layer 1341, the free magnetization layer 1340 and a protective layer 1350 which are stacked subsequently on the bottom shielding layer 1110.

The underlayer 1310 may be made of Ta etc., and functions as controlling the exchange coupling between the antiferromagnetic layer 1320 and the ferromagnetic layer 1344 and developing the degree of crystallinity of the spin valve film 1200 entirely.

The antiferromagnetic layer 1320 may be made of PtMn alloy, X—Mn alloy (X=at least one selected from the group consisting of Pd, Ir, Rh, Ru, Os, Ni, Fe), or Pt—Mn—X1 (X1=at least one selected from the group consisting of Pd, Ir, Rh, Ru, Au, Ag, Os, Cr, Ni). The selected alloy is thermally treated so as to be provided as the antiferromagnetic layer 1320 to exhibit the large exchange coupling magnetic field. The antiferromagnetic layer 1320 may contain at least one of Ar, Ne, Xe, Kr as impurity according to the forming process such as sputtering.

The antiferromagnetic layer 1320 fixes (pins) the magnetization direction D1 of the ferromagnetic layer 1344. As described later, by thermally treating the antiferromagnetic layer 1320 under the condition that the ferromagnetic layer 1344 is stacked on the antiferromagnetic layer 1320, the magnetization direction D1 of the ferromagnetic layer 1344 is fixed.

As described above, the magnetization direction D1 of the ferromagnetic layer 1344 is fixed by the antiferromagnetic layer 1320. In FIG. 2, the magnetization direction D1 is directed to the front of the page space from the back of the page space.

The ferromagnetic layer 1344, the magnetic coupling layer 1343 and the fixed magnetization layer 1342 constitute a so-called synthetic antiferromagnet (SyAF). Namely, the ferromagnetic layer 1344 and the fixed magnetization layer 1342 are antimagnetically coupled with one another via the magnetic coupling layer 1343. As a result, the magnetization direction D3 of the fixed magnetization layer 1342 becomes antiparallel to the magnetization direction D1 of the ferromagnetic layer 1344.

The ferromagnetic layer 1344 and the fixed magnetization layer 1342 is normally made of at least one selected from the group consisting of Fe, Co, Ni and Mn, and configured as a single-layered structure or a multilayered structure. For example, the ferromagnetic layer 1344 and the fixed magnetization layer 1342 may be made of a CoFe alloy layer and a Cu layer to be stacked.

The magnetic coupling layer 1342 functions mainly as dividing the magnetic coupling between the free magnetization layer 1340 and the fixed magnetization layer 1342 and thus, controlling the interlayer coupling magnetic field Hin between the free magnetization layer 1340 and the fixed magnetization layer 1342. In this case, the thickness of the intermediate layer 1341 is preferably set within a range of 0.4 to 1.1 nm.

The intermediate layer 1341 may be made of non-magnetic metal with high electric conductivity such as Cu or Au, for example. In this case, the magneto-resistance effect film 1200 constitutes a so-called GMR film and the magneto-resistance effect element 1100 constitutes a so-called GMR element. In this case, the interlayer coupling magnetic field Hin can be set within 20 to 100 Oe.

The intermediate layer 1341 may be made of oxide such as Al₂O₃. In this case, the magneto-resistance effect film 1200 constitutes a so-called TMR film and the magneto-resistance effect element 1100 constitutes a so-called TMR element. In this case, the interlayer coupling magnetic field Hin can be set within 20 to 100 Oe.

The intermediate layer 1341 may be made of an insulator (Al₂O₃) with conductors (Cu) therein. In this case, the conductors are required to be contacted with the fixed magnetization layer 1342 and the free magnetization layer 1340 throughout the intermediate layer 1341. In this case, the conductors constitute current-confined paths (CCPs), and the magneto-resistance effect film 1200 constitutes a CCP-CPP film and the magneto-resistance effect element 1100 constitutes a CCP-CPP element.

The free magnetization layer 1340 is configured such that the magnetization is changed in accordance with an external magnetic field and thus, made of a NiFe alloy layer or a multilayered structure of NiFe alloy/CoFe alloy. The protective layer 1350 functions as protecting the spin valve film 1200 through the manufacturing process after the formation of spin valve film 1200, and made of Cu, Ta or Ru, for example.

The magnetic domain controlling films 1120 are formed at both sides of the spin valve film 1200 in the recording track direction of the magnetic recording medium. Insulating layers 1150 are formed between the spin valve film 1200 and the magnetic domain controlling films 1120, respectively. The magnetic domain controlling films 1120 (preferably made of CoPt alloy or CoCrPt alloy) is formed on the insulating layers 1150 (preferably made of Al₂O₃ or AlN).

The magnetic domain controlling films 1120 functions as a longitudinal biasing mechanism and thus, applies a longitudinal biasing magnetic field to the free magnetization layer 1340. Namely, the magnetic domain controlling film 1120 has the magnetization direction D4 which defines the direction of the longitudinal biasing magnetic field. Generally, the direction of the longitudinal biasing magnetic field is set parallel to the film surface of the magneto-resistance effect film and perpendicular to the magnetization direction D3 of the fixed magnetization layer 1342.

The magnetization direction Df₀ (initial magnetization direction Df₀) of the free magnetization layer 1340 under no external magnetic field H can be defined by the longitudinal biasing magnetic field. In FIG. 3, since the magnetization direction D4 is oriented to the right, the initial magnetization direction Df₀ is also oriented to the right. According to the interlayer coupling magnetic field Hin, however, the initial magnetization direction Df₀ is slightly shifted from the magnetization direction D4 clockwise. The magnetization direction D4 may be oriented to the left.

The distance between the magnetic domain controlling film 1120 and the free magnetization layer 1340 can be controlled by adjusting the thickness of the insulating layer 1150. In this embodiment, it is desired that the distance between the magnetic domain controlling film 1120 and the free magnetization layer 1340 is set to 5 nm or less by adjusting the thickness of the insulating layer 1150. In this case, the requirement of the medium signal reproducing efficiency of less than 15% can be easily satisfied. The lower limited value of the medium signal reproducing efficiency is not restricted only if the intended reproducing signal can be obtained effectively.

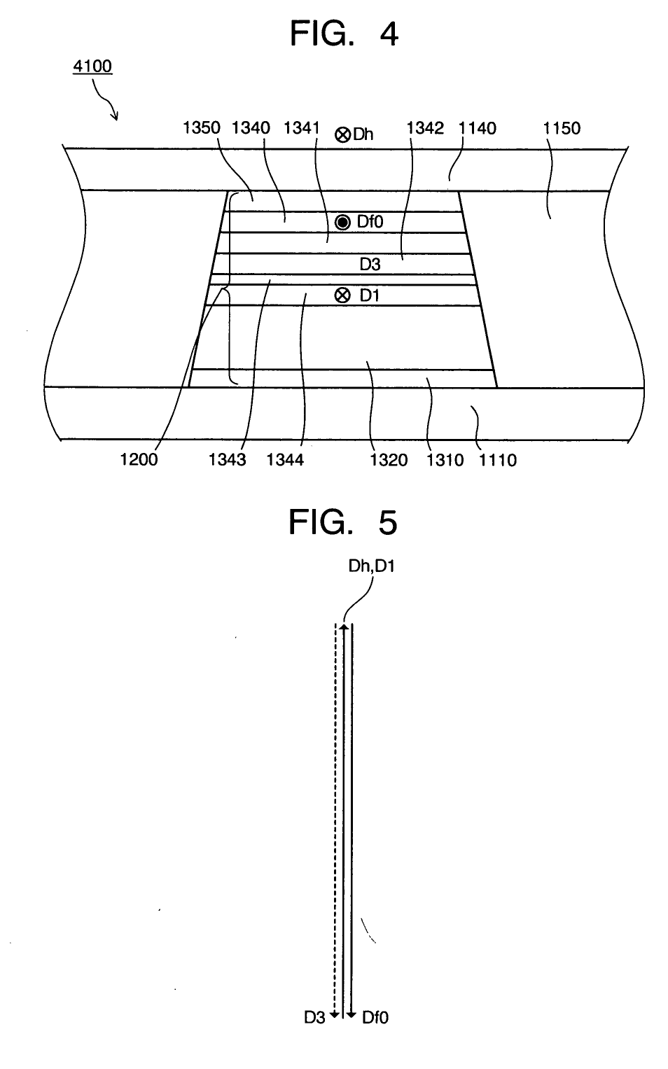

In the magneto-resistance effect element 4100 shown in FIG. 4, the magnetic domain controlling films 1120 are also made of the insulating layers 1150, respectively. The magneto-resistance effect element 4100 is utilized for obtaining an R—H curve in an element with no magnetic domain controlling films so as to measure the interlayer coupling magnetic field Hin. FIG. 5 is a schematic view showing the directions of the magnetizations of the magneto-resistance effect shown in FIG. 4, as viewed from the top thereof. Since the magneto-resistance effect element 4100 has no magnetic domain controlling film, the magnetization direction Df₀ becomes antiparallel to the magnetization direction D3 according to the interlayer coupling magnetic field Hin.

The inventors paid an attention to the STIN of the multilayered film when the longitudinal biasing magnetic field is applied to the multilayered film, and thus, found out the controlling method of the STIN.

In the GMR element, the signal magnetic field from the magnetic recording medium and the longitudinal biasing magnetic field are applied to the multilayered film, which is different from a device such as MRAM (Magnetic Random Access Memory) by use (Parameter requirement of Magneto-Resistance Effect Element)

Then, the parameter requirement of the magneto-resistance effect element will be described.

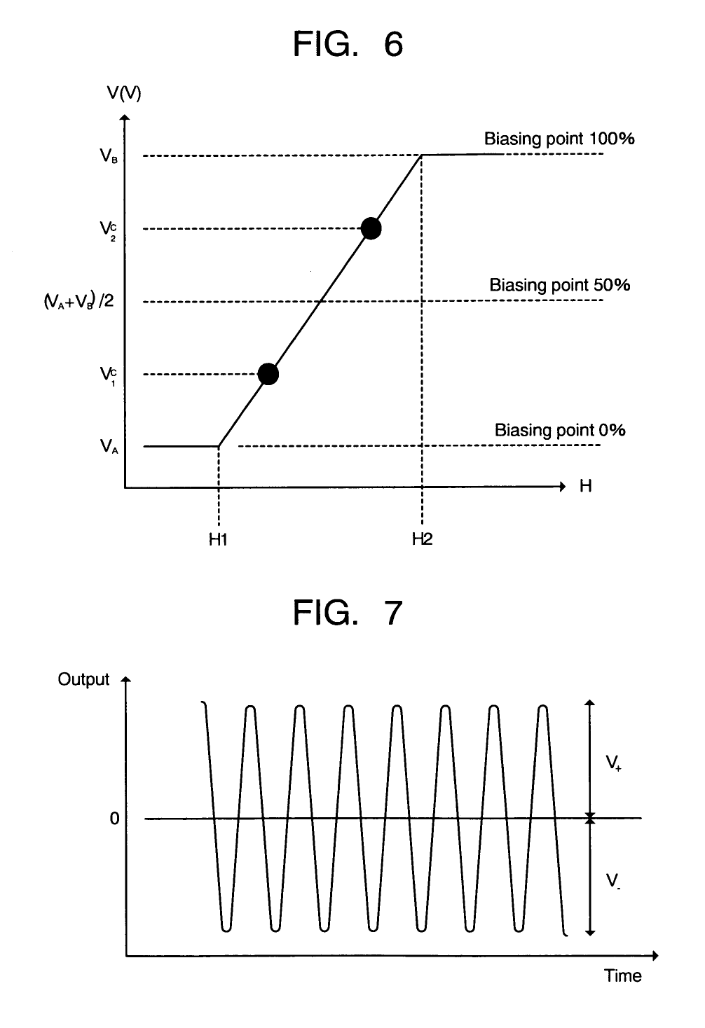

First of all, the meaning of the biasing point will be described. FIG. 6 is a schematic view for explaining the biasing point of the magneto-resistance effect element. The abscissa axis designates the signal magnetic field H and the ordinate axis designates the output V of the vertical magneto-resistance effect element 1100.

In this embodiment, a constant sense current I is flowed in the vertical magneto-resistance effect element 1100 so as to change the signal magnetic field H and thus, measure the output (voltage) of the vertical magneto-resistance effect element 1100. As a result, the graph exhibits the relation between the signal magnetic field H and the output (voltage) V (herein, the graph is called as a “transfer curve”).

When the signal magnetic field H is changed positively and negatively, the output V is varied within a given range of H1 to H2. Then, the output V becomes constant V_{A} or V_{B} beyond the range of H1 to H2. In this case, the output V is set to Vc when the signal magnetic field H is set to zero (in FIG. 6, the zero point is designated as “V_{C1}” and “V_{C2}”).

The biasing point BP is a factor exhibiting the position of the output V_{C} within the range of V_{B} to V_{C} when the signal magnetic field H is zero, and can be defined as the following equation (1):

BP=(V_{C}−V_{A})/(V_{B}−V_{A})×100[%] (1)

The positive and negative of the signal magnetic field H can be defined as follows: Namely, the positive direction of the signal magnetic field H means that the signal magnetic field H is antiparallel to the magnetization direction D3 of the fixed magnetization layer 1342 (parallel to the magnetization direction D1 of the ferromagnetic layer 1344 as designated as Dh in FIG. 2) and the negative direction of the signal magnetic field H means that the signal magnetic field H is parallel to the magnetization direction D3 of the fixed magnetization layer 1342.

In FIG. 6, in the case that the output V is set to V_{A}, V_{B} and (V_{A}+V_{B})/2 when the signal magnetic field H is zero, the biasing point BP is set to 0%, 100% and 50%, respectively. In the case that the output V is set to V_{C1} and V_{C2} when the signal magnetic field H is zero, the biasing point BP is set less than 50% in the former case and larger than 50% in the latter case.

The calculating method of the biasing point BP will be described concretely. In this embodiment, the application voltage for the GMR element 1100 (the voltage to be applied between the bottom shielding layer 1110 and the top shielding layer 1140) is set low enough (preferably within a range of several mV to 30 mV). In this case, the intended output V can be obtained under the condition of small STIN so that the biasing point can be calculated precisely.

Generally, wirings are connected with the bottom shielding layer 1110 and the top shielding layer 1140, respectively, for flowing the current to the layers 1110 and 1140. Therefore, voltage drop may occur at the wirings so that the application voltage to the element may be different from the inherent application voltage to the layers 1110 and 1140. In many cases, however, since the resistance of the wiring is tenth or less as large as the resistance of the spin valve film, the voltage drop of the wiring can be neglected. Therefore, the inherent voltage to the layers 1110 and 1140 can be substituted with the application voltage for the wirings thereof.

In the case that the signal magnetic field H is sufficiently low (negative), since the magnetization of the fixed magnetization layer 1342 becomes almost parallel to the magnetization of the free magnetization layer 1340, the output V is set to a small value of V_{A}. In the case that the signal magnetic field H is sufficiently high (positive), since the magnetization of the fixed magnetization layer 1342 becomes almost antiparallel to the magnetization of the free magnetization layer 1340, the output V is set to a larger value of V_{B}. The output V_{C} is set to a given value within a range of V_{A} to V_{B} when the signal magnetic field H is zero. In this case, the biasing point BP can be calculated by the equation (1).

Suppose that the resistance when the signal magnetic field H is sufficient low (negative) is defined as R_{A}, the resistance when the signal magnetic field H is sufficient high (positive) is defined as R_{B} and the resistance when the signal magnetic field H is zero is defined as R_{C}. In this case, the biasing point BP can be represented by the equation (2):

BP=(R_{C}−R_{A})/(R_{B}−R_{A})×100[%] (2)

FIG. 7 is a schematic view for explaining the asymmetry in output of the magneto-resistance effect element. The abscissa axis designates time and the ordinate axis designates the output V of the vertical magneto-resistance effect element 1100. The positive and negative of the signal magnetic field is defined as described above. When the difference in output between the maximum positive signal magnetic field and the zero signal magnetic field is defined as V₊ and the difference in output between the maximum negative signal magnetic field and the zero signal magnetic field is defined as V₋, the asymmetry can be represented by the equation

(V₊−V_)/(V₊+V₋) (3)

When the signal waveform in output at the positive signal magnetic field is symmetric for the signal waveform in output at the negative magnetic field, the asymmetry becomes zero. In this embodiment, if the asymmetry is set positive, the STIN can be suppressed. The positive asymmetry means that the (V₊−V₋)/(V₊+V₋) as represented by the equation (3) is set positive (>0). The upper limit of the asymmetry can be determined by another component such as a signal processing circuit of the magnetic reproducing/recording device.

When the asymmetry is set to zero, the biasing point is set to 50%. Schematically, the biasing point is increased as the asymmetry is decreased and the biasing point is decreased as the asymmetry is increased. Empirically, the asymmetry can not be correlated with the biasing point on one-on-one level. However, the asymmetry can be easily measured in the magnetic recording/reproducing device so that the biasing point can be approximately determined by the asymmetry.

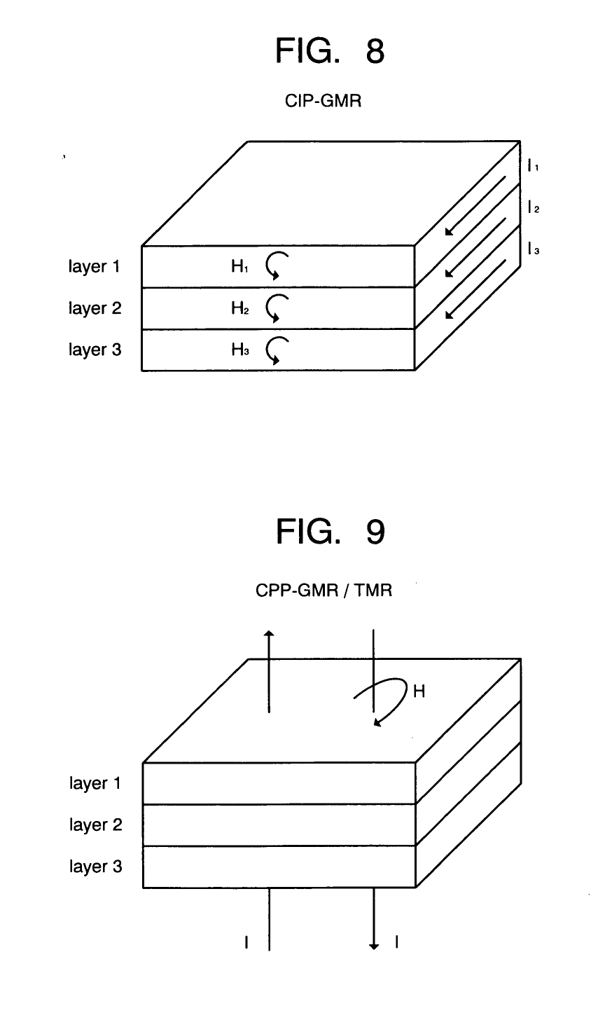

Then, the difference in meaning between the asymmetry and the biasing point will be described. FIGS. 8 and 9 are schematic views showing the magnetic fields generated by the current flowed in the CIP-GMR element and the CPP-GMR element/TMR element. The direction of the magnetic field depends on the direction of the current flowing in the element. For simplification, all of the CIP-GMR element and the CPP-GMR element/TMR element include the magneto-resistance effect film made of layers 1 to 3.

In the CIP-GMR element, since the currents I1 to I3 are flowed parallel to the film surfaces of the layers 1 to 3, the amplitudes of the currents I1 to I3 are different from one another. Therefore, the magnetic field H1 (in the layer 1), the magnetic field H2 (in the layer 2) and the magnetic field H3 (in the layer 3), which are generated from the currents I1 to I3, are different from one another. In the CIP-GMR element, therefore, the asymmetry and biasing point are changed on the magnetic fields H1, H2 and H3. In this point of view, it is important in the CIP-GMR element to control the magnetic fields H1, H2 and H3. The controlling technique is disclosed in Reference 1.

In the CPP-GMR element/TMR element, in contrast, the current is flowed perpendicular to the film surfaces of the layers 1 to 3 across the layers 1 to 3 so that the currents flowing in the layers 1 to 3 are substantially equal to one another and thus, the magnetic fields generated by the currents are substantially equal to one another. In the CCP-GMR element/TMR element, therefore, the asymmetry and biasing point are not changed on the magnetic fields generated in the layers 1 to 3.

Then, the generating mechanism of STIN will be described. The STIN is generated on the change in the direction of the magnetization in the free magnetization layer 1340 originated from the magnetization shift between the fixed magnetization layer 1342 and the free magnetization layer 1340 through the spin angular momentums of the conduction electrons contributing the current flowing in the element.

### <In CPP-GMR Element/TMR Element>

Suppose that the magnetization of the fixed magnetization layer 1342 is antiparallel to the magnetization of the free magnetization layer 1340. In this case, if a current is flowed to the fixed magnetization layer 1342 from the free magnetization layer 1340, the magnetization of the free magnetization layer 1340 is inverted and the magnetic resistance of the element becomes small. The reason will be described hereinafter.

In this case, the electrons are flowed to the free magnetization layer 1340 from the fixed magnetization layer 1342 because the electron direction is opposite to the current direction. When the electrons are passed through the fixed magnetization layer 1342, the spin angular momentums of the electrons are polarized in the same direction as the magnetization of the fixed magnetization layer 1342. The polarized electrons are flowed into the free magnetization layer 1340 via the intermediate layer 1341. In this case, the spin angular momentums are transferred to the free magnetization layer 1340 from the electrons. As a result, the magnetization of the free magnetization layer 1340 is inverted so that the magnetization of the free magnetization layer 1340 can be parallel to the magnetization of the fixed magnetization layer 1342.

In this way, the magnetization of the free magnetization layer 1340 becomes parallel to the magnetization of the fixed magnetization layer 1342 by the electrons flowing into the free magnetization layer 1340 from the fixed magnetization layer 1342.

Then, suppose that the magnetization of the fixed magnetization layer 1342 is parallel to the magnetization of the free magnetization layer 1340. In this case, if a current is flowed to the free magnetization layer 1340 from the fixed magnetization layer 1342, the magnetization of the free magnetization layer 1340 is inverted and the magnetic resistance of the element becomes large. The reason will be described hereinafter.

In this case, the electrons are flowed to the fixed magnetization layer 1342 from the free magnetization layer 1340 because the electron direction is opposite to the current direction. In this case, all of the electrons are not polarized. The non-polarized electrons are reflected at the interface between the fixed magnetization layer 1342 and the intermediate layer 1341 and returned to the free magnetization layer 1340 so that the spin angular momentums of the non-polarized electrons are transferred to the free magnetization layer 1340. As a result, the magnetization of the free magnetization layer 1340 is inverted so that the magnetization of the free magnetization layer 1340 can be antiparallel to the magnetization of the fixed magnetization layer 1342.

In this way, the magnetization of the free magnetization layer 1340 becomes antiparallel to the magnetization of the fixed magnetization layer 1342 by the electrons flowing into the fixed magnetization layer 1342 from the free magnetization layer 1340 and reflected at the interface between the fixed magnetization layer 1342 and the intermediate layer 1341. Since the ratio of the electrons reflected at the interface to the electrons passing through the interface is small, the inversion of the magnetization of the free magnetization layer 1340 caused by the reflected electrons becomes small in the comparison with the inversion of the magnetization of the free magnetization layer 1340 caused by the passing electrons.

As a result, when the electrons are flowed to the free magnetization layer 1340 from the fixed magnetization layer 1342, the STIN is likely to occur. When the electrons are flowed to the fixed magnetization layer 1342 from the free magnetization layer 1340, the STIN is unlikely to occur.

Namely, the STIN can be reduced by flowing the electrons to the fixed magnetization layer 1342 from the free magnetization layer 1340 (flowing the current to the free magnetization layer 1340 from the fixed magnetization layer 1342). In this embodiment, if the electrons are flowed in the opposite direction to the above-described direction, the STIN can be reduced because the some parameters such as the asymmetry can satisfy the requirements.

In this embodiment, the element resistance RA in the current flow direction is set to 1.5 Ωμm² or less. If the element resistance RA is set beyond 1.5 Ωμm², the magnetic resistance can not be reduced even though the current is flowed to the fixed magnetization layer 1342 from the free magnetization layer 1340 so that the STIN cannot be sufficiently suppressed. It is desired that the element resistance RA becomes as small as possible. Herein, the element resistance RA is defined as a resistance per unit area when a current is flowed to the fixed magnetization layer 1342

### <In CIP-GMR Element>

It is not required to consider STIN in the CIP-GMR element. Namely, in the CIP-GMR element, the current is concentrated into the layer with the highest electric conduction (generally, into the intermediate layer made of Cu). Therefore, it is considered that the interlayer spin angular momentum transfer can not be generated. In this point of view, it is considered that the STIN is specific for the CPP-GMR element/TMR element.

### <Control of Asymmetry by Interlayer Coupling Magnetic Field>

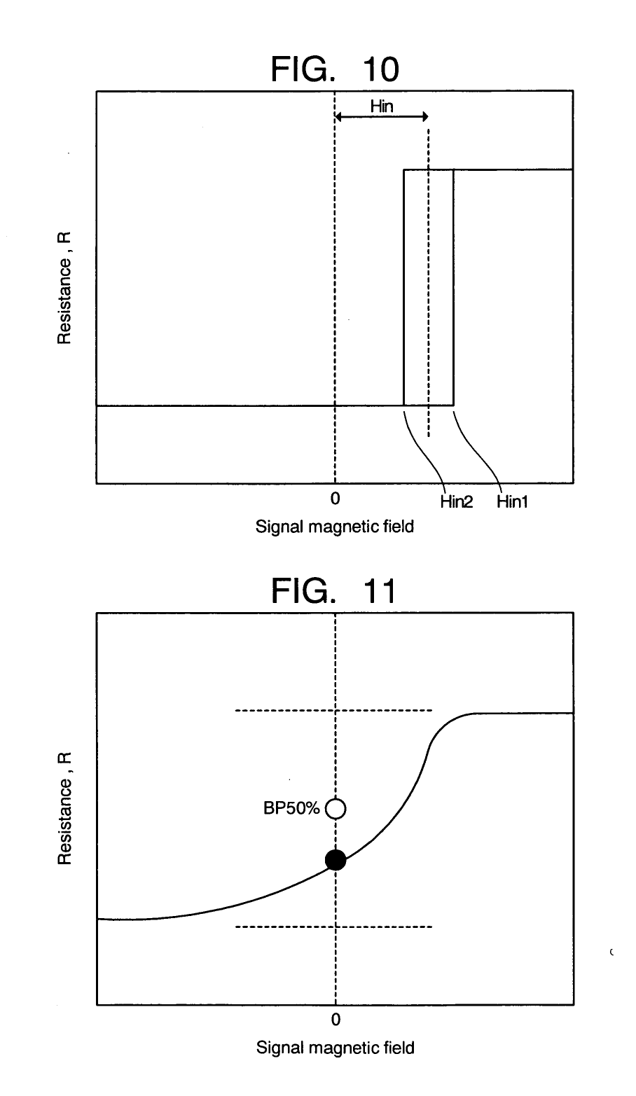

The interlayer coupling magnetic field Hin is generated between the fixed magnetization layer 1342 and the free magnetization layer 1340 via the intermediate layer 1341. FIG. 10 shows the magnetic field dependence of the resistance in the magneto-resistance effect element 4100 without the magnetic domain controlling films 1120 when the signal magnetic field is changed. When the signal magnetic field is sufficiently small or large, the resistance becomes constant. When the signal magnetic field is increased to Hin1 beyond zero, the resistance is increased remarkably. Then, when the signal magnetic field is decreased beyond Hin2 less than Hin1, the resistance is decreased remarkably. The Hin is defined as an average value of Hin1 and Hin2.

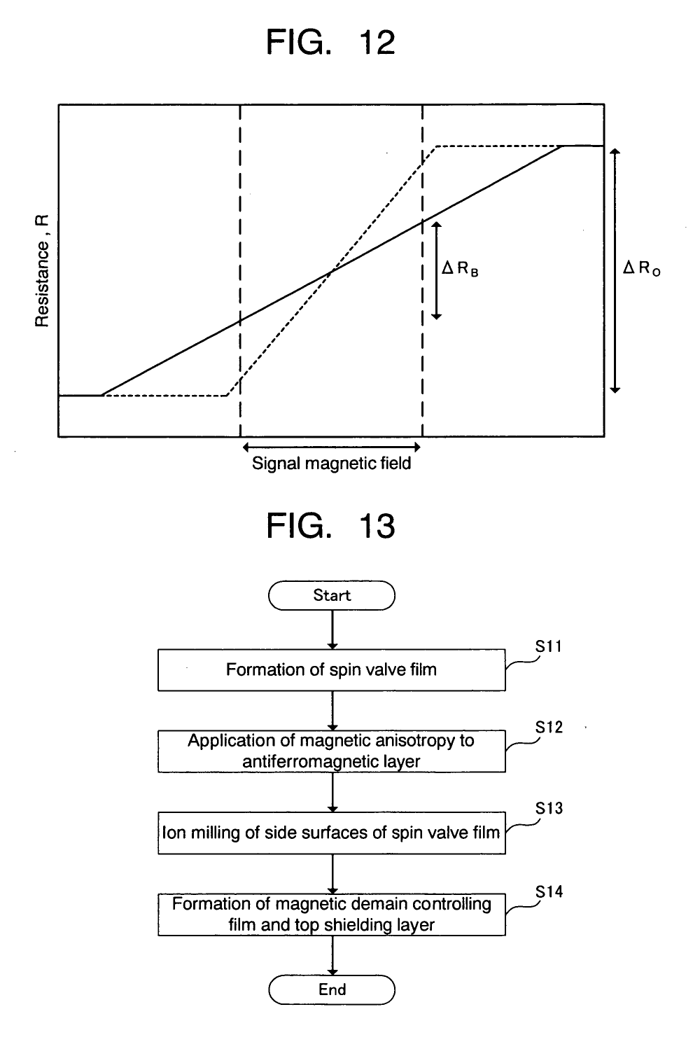

FIG. 11 shows the R—H curve of the magneto-resistance effect element 1100 which is configured as the magneto-resistance effect element 4100, according to FIG. 10. When the interlayer coupling magnetic field Hin is set to zero, the biasing point BP becomes idealistic 50% and the asymmetry becomes zero. Practically, the biasing point is shifted from the idealistic 50% and the asymmetry is shifted from zero due to the fluctuation in thickness of the fixed magnetization layer and the like. When the interlayer coupling magnetic field Hin is beyond 30 Oe, the biasing point BP becomes less than 50% and the asymmetry becomes positive. In the CCP-CPP element, if the thickness of the intermediate layer is set to 1.1 nm or less from 2 nm which is normal thickness at present, the interlayer correlation is increased so that the interlayer coupling magnetic field Hin can be increased to 30 Oe or more.

If the thickness of the intermediate layer is set too thin, the handling of the magneto-resistance effect element may be deteriorated. Therefore, the lower limited thickness of the intermediate layer is preferably set to 0.4 nm. In this case, the interlayer coupling magnetic field Hin becomes 100 Oe.

The interlayer coupling magnetic field Hin can be easily measured as follows. First of all, a multilayered film, which is configured as the magneto-resistance effect element, is formed, and then, the magnetization of the multilayered film is measured by a magnetization measuring device. In this case, the resistance of the multilayered film is remarkably changed at the same external magnetic field as the one in FIG. 6 so that the intended Hin can be obtained.

### <Control of Medium Signal Reproducing Efficiency>

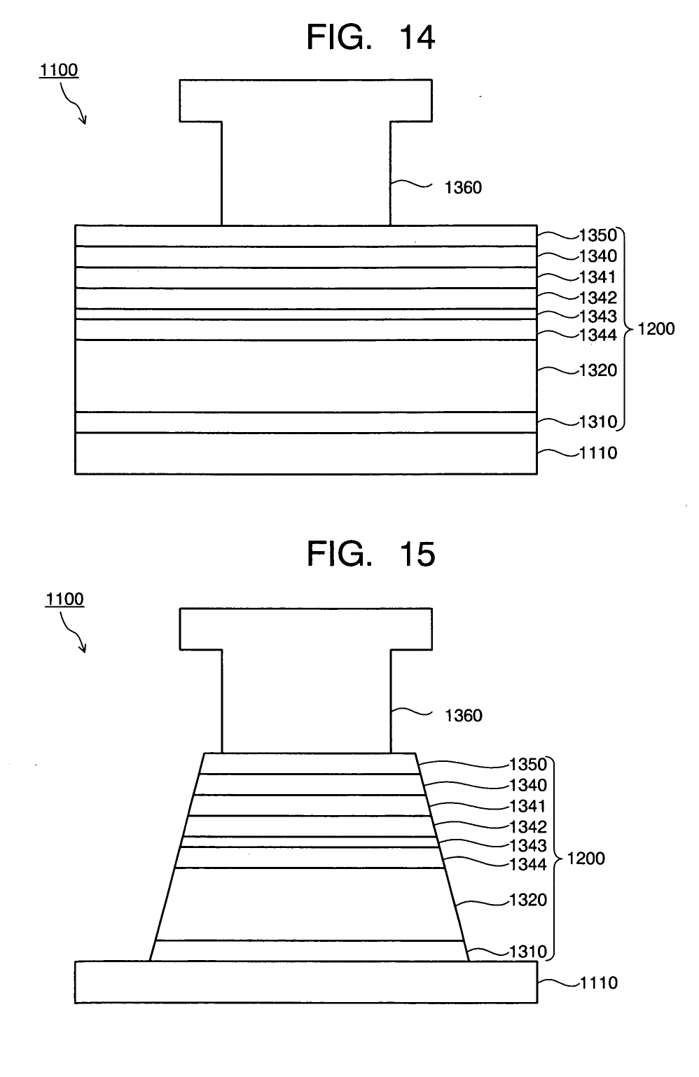

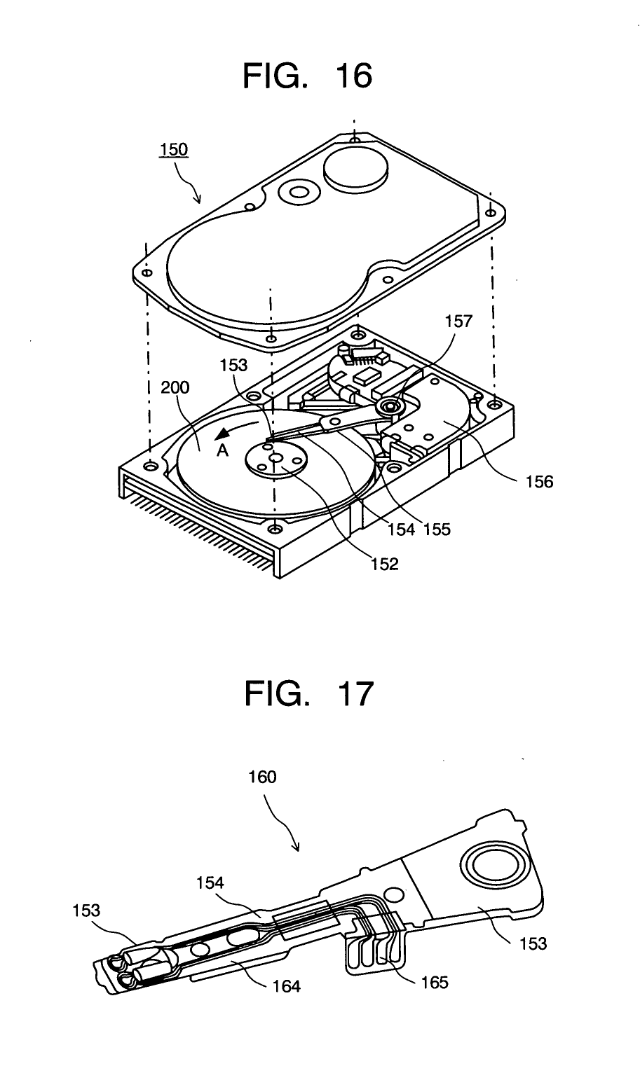

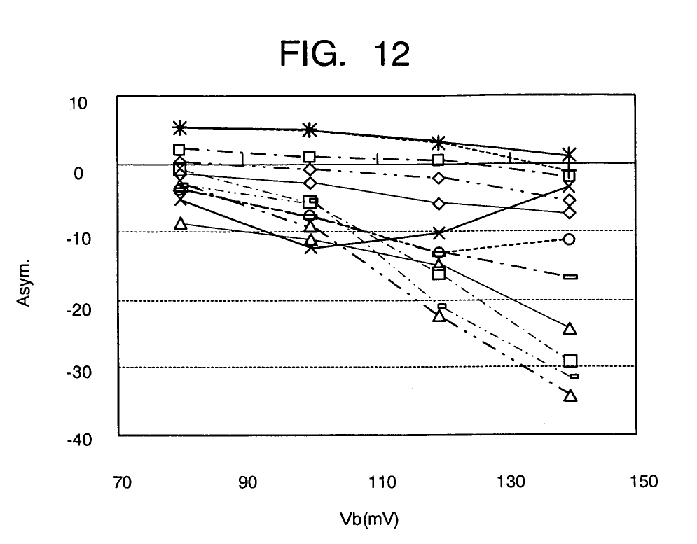

FIG. 12 is an explanatory view of medium signal reproducing efficiency EF_{M}. When the resistance change ratio per unit signal magnetic field is defined as ΔR_{B}, the medium signal reproducing efficiency EF_{M} can be represented by the equation (4):

EF_{M}=ΔR_{B}/ΔR₀×100(%) (4)

Since the resistance change ratio ΔR_{B} is decreased as the magnetic field from the magnetic domain controlling films is increased, the medium signal reproducing efficiency EF_{M} is decreased, which means that relative angle φ between the magnetization direction Df of the free magnetization layer 1340 and the magnetization direction D3 of the fixed magnetization layer 1342 is relatively small. If the relative angle φ becomes relatively large, the spin transfer becomes conspicuous. Therefore, when the magnetic field from the magnetic domain controlling films is increased so as to decrease the medium signal reproducing efficiency, the spin transfer can be suppressed so that the S/N ratio of the magneto-resistance effect element can be developed.

In FIG. 2, when the distance 1370 between the free magnetization layer 1340 and the magnetic domain controlling films 1120 is decreased, the intensity of the magnetic field from the magnetic domain controlling films 1120 to be applied to the free magnetization layer 1340 becomes high. Although the distance 1370 is set within a range of 7 to 10 nm at present, the distance 1370 can be set to 5 nm or less. In the latter case, the medium signal reproducing efficiency EFM can be reduced to 15% or less. The lower limited value of the distance 1370 can be determined on the element manufacturing technique not in view of the reduction of the STIN.

Then, the manufacturing process of the element will be described. FIG. 13 is a flowchart for manufacturing the element 1100. FIGS. 14 and 15 are cross sectional views showing the magneto-resistance effect element 1100 under the manufacture according to the process shown in FIG. 13. The magneto-resistance effect element 4100 can be manufactured in the same manner as the magneto-resistance effect element 1100 except some steps. With the magneto-resistance effect element 4100, therefore, the steps different from the steps in the manufacturing method of the element 1100 will be described.

### (1) Formation of Spin Valve Film 1200 (Step S11)

The spin valve film 1200 is formed on a substrate (not shown). Namely, the bottom shielding layer 1110, the underlayer 1310, the antiferromagnetic layer 1320, the ferromagnetic layer 1344, the magnetic coupling layer 1343, the fixed magnetization layer 1342, the intermediate layer 1341 and the free magnetization layer 1340 are subsequently formed on the substrate (refer to FIG. 14). FIG. 14 shows the state where a resist layer 1360 is formed. In this case, if the thicknesses and the sorts of material of the fixed magnetization layer 1342 and the ferromagnetic layer 1344 are controlled, the equation (3) is satisfied and the biasing point can be controlled.

Each layer can be formed by means of sputtering method. As the sputtering method, DC magnetron sputtering method, RF magnetron sputtering method, ion beam sputtering method, long throw sputtering method, collimation sputtering method and the combination thereof can be exemplified.

### (2) Application of Exchange Coupling Magnetic Field to Antiferromagnetic Layer 1320 (Step S12)

Then, the exchange coupling magnetic field (magnetic anisotropy) is applied to the antiferromagnetic layer 1320, concretely by the combination of magnetic field application and thermal treatment. Namely, the antiferromagnetic layer 1320 is thermally treated at a temperature T higher than the blocking temperature under the application of the magnetic field H, and cooled down.

The blocking temperature means the temperature where the magnetic anisotropy of the antiferromagnetic layer 1320 disappears (namely, the temperature at which the exchange coupling between the antiferromagnetic layer 1320 and the ferromagnetic layer 1344 is disappeared). In this point of view, when the temperature is increased beyond the blocking temperature, the magnetic anisotropy of the antiferromagnetic layer 1320 disappears once. Thereafter, since the temperature is cooled down less than the blocking temperature, the exchange coupling magnetic field (magnetic anisotropy) is newly generated at the antiferromagnetic layer 1320 in accordance with the direction of the magnetic field to be applied.

The intensity of the exchange coupling magnetic field depends on the crystal grain size distribution and the degree of vacuum at film forming step. In the case that the antiferromagnetic layer is made of PtMn, the exchange coupling magnetic field is increased as the thickness of the antiferromagnetic layer is increased. In the case that the antiferromagnetic layer is made of IrMn, the exchange coupling magnetic field is decreased as the thickness of the antiferromagnetic layer is increased.

The magnetic field H is applied to the antiferromagnetic layer 1320 so that the direction of the magnetic field H can be orthogonal to the magnetization direction of the magnetic domain controlling films 1120. In this case, the relative angle θ between the magnetization direction D4 of the magnetic domain controlling films 1120 and the magnetization direction D1 of the ferromagnetic layer 1344 becomes 90 degrees so that the biasing point is set to 50% and the element sensitivity can be enhanced.

### (3) Ion Milling of Side Surfaces of Spin Valve Film 1200 (Step S13)

After the resist layer 1360 is formed on the spin valve film 1200 (refer to FIG. 14), the side surfaces of the spin valve film 1200 (the protective layer 1350 through the underlayer 1310) are removed by means of ion milling down to underlayer 1310 partially (refer to FIG. 15).

### (4) Formation of Magnetic Domain Controlling Films 1120 and Top Shielding Layer 1140 (Step S14)

Then, the insulating layers 1150 and the magnetic domain controlling films 1120 are formed on the side surfaces of the spin valve film 1200 after the removal by the ion milling. Then, after the resist layer 1360 is removed, the top shielding layer 1140 is formed (refer to FIG. 2). With the magneto-resistance effect element 4100, the insulating layers 1150 are formed at the parts for the magnetic domain controlling films 1120 to be formed, instead of the films 1120.

### (Magnetic Recording/Reproducing Device)

Then, the magnetic recording/reproducing device according to an embodiment will be described. The magneto-resistance effect element as described above is installed in advance in an all-in-one magnetic head assembly allowing both the recording/reproducing, and mounted as the head assembly at the magnetic recording/reproducing device.

FIG. 16 is a perspective view illustrating the schematic structure of the magnetic recording/reproducing device. The magnetic recording/reproducing device 150 illustrated in FIG. 16 constitutes a rotary actuator type magnetic recording/reproducing device. In FIG. 16, a magnetic recording disk 200 is mounted to a spindle 152 to be turned in the direction designated by the arrow A by a motor (not shown) which is driven in response to control signals from a drive unit controller (not shown). In FIG. 16, the magnetic recording/reproducing apparatus 150 may be that provided with a single magnetic recording disk 200, but with a plurality of magnetic recording disks 200. The magnetic recording disk 200 may be a longitudinal magnetic recording type disk configured such that the magnetization direction of recording bit is oriented parallel to the surface of the disk. Alternatively, the magnetic recording disk 200 may be a perpendicular magnetic recording type disk configured such that the magnetization direction of recording bit is oriented perpendicular to the surface of the disk.

A head slider 153, which functions as recording/reproducing information to be stored in the magnetic recording disk 200 is mounted on a tip of a suspension 154 of a thin film type. The head slider 153 mounts at the tip the magnetic head containing the magnetic resistance effect element as described in above embodiments.

When the magnetic recording disk 200 is rotated, such a surface (ABS) of the head slider 153 as being opposite to the magnetic recording disk 200 is floated from on the main surface of the magnetic recording disk 200. Alternatively, the slider may constitute a so-called “contact running type” slider such that the slider is in contact with the magnetic recording disk 200.

The suspension 154 is connected to one edge of the actuator arm 155 with a bobbin portion supporting a driving coil (not shown) and the like. A voice coil motor 156 being a kind of a linear motor is provided at the other edge of the actuator arm 155. The voice coil motor 156 is composed of the driving coil (not shown) wound around the bobbin portion of the actuator arm 155 and a magnetic circuit with a permanent magnet and a counter yoke which are disposed opposite to one another so as to sandwich the driving coil.

The actuator arm 155 is supported by ball bearings (not shown) provided at the upper portion and the lower portion of the spindle 157 so as to be rotated and slid freely by the voice coil motor 156.

FIG. 17 is an enlarged perspective view illustrating a portion of the magnetic head assembly positioned at the tip side thereof from the actuator arm 155, as viewed from the side of the magnetic recording disk 200.

As illustrated in FIG. 17, the magnetic head assembly 160 has the actuator arm 155 with the bobbin portion supporting the driving coil and the like. The suspension 154 is connected with the one edge of the actuator arm 155. Then, the head slider 153 with the magnetic head containing the magneto-resistance effect element as defined in above-embodiments is attached to the tip of the suspension 154.

The suspension 154 includes a lead wire 164 for writing/reading signals, where the lead wire 164 is electrically connected with the respective electrodes of the magnetic head embedded in the head slider 153. In the drawing, reference numeral “165” denotes an electrode pad of the assembly 160.

In the magnetic recording/reproducing device illustrated in FIGS. 16 and 17, since the element as described in the above embodiments is installed, the information magnetically recorded in the magnetic recording disk 200 under higher density recording than normal recording can be read out properly.

### EXAMPLE

In Example, the GMR element 1100 was manufactured and the magnetic head containing the element 1100 was manufactured. The underlayer 1310 was made of Ta [5 nm], and the antiferromagnetic layer 1320 was made of PtMn [15 nm], and the ferromagnetic layer 1344 was made of Co₉₀Fe₁₀ [3.4 nm]. The magnetic coupling layer 1343 was made of Ru [0.85 nm], and the fixed magnetization layer 1342 was made of Fe₅₀Co₅₀ [3.0 nm], and the free magnetization layer 1340 was made of Co₉₀Fe₁₀ [1 nm]/Ni₈₃Fe₁₇ [3.5 nm], and the protective layer 1350 was made of Cu [5 nm]. The intermediate layer was made of Al₂O₃ with Cu current paths. The magnetic domain controlling films 1120 were made of CoCrPt.

Then, the magnetic recording/reproducing device containing the magnetic head was manufactured. FIG. 18 is a graph showing the relation between the asymmetry and the biasing voltage Vb in the magnetic recording/reproducing device. The biasing voltage can be represented by the multiplication of a sense current and the resistance of the magnetic head. The asymmetry less than zero at the biasing voltage of 80 mV is not changed remarkably by increasing the biasing voltage. The asymmetry more than zero at the biasing voltage of 80 mV is changed remarkably by increasing the biasing voltage, that is, the sense current, which means the conspicuous generation of STIN and thus, the waveform of signal obtained from the magnetic recording/reproducing device is distorted remarkably.

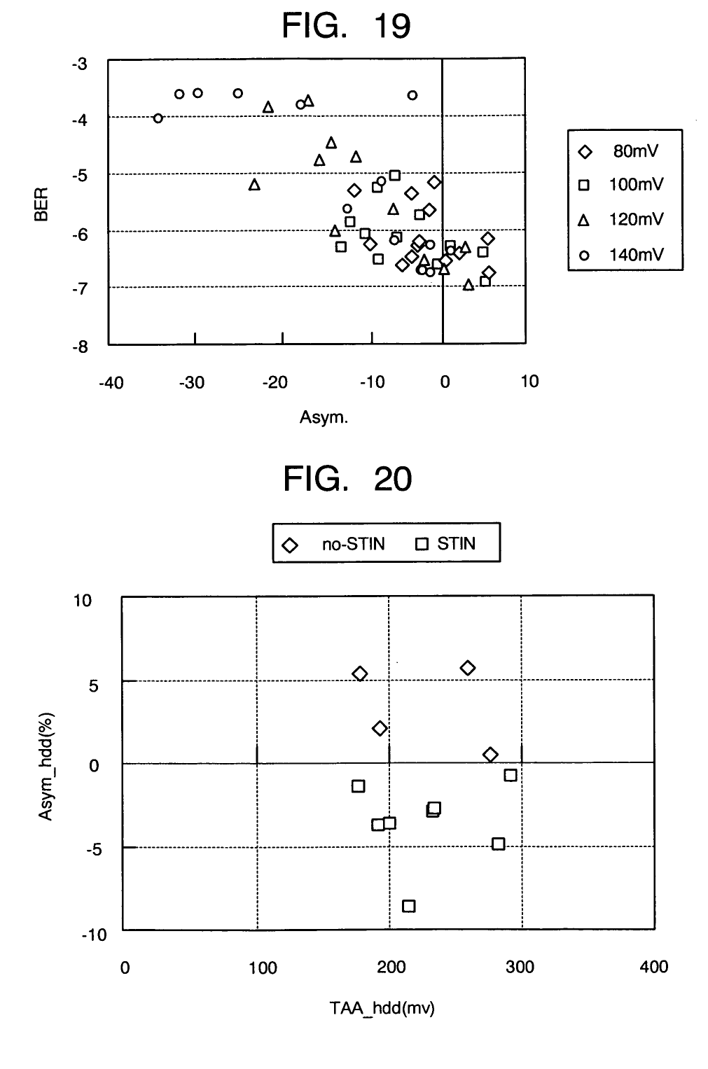

FIG. 19 is a graph showing the relation between the BER and the asymmetry in the magnetic recording/reproducing device. In the case that the asymmetry is changed remarkably by increasing the biasing voltage, the BER is deteriorated remarkably. FIG. 20 is a graph showing the relation between the asymmetry and the TAA (head output) in the magnetic recording/reproducing device. In the negative asymmetry, the STIN is generated remarkably as the biasing voltage is increased. In the positive asymmetry, the STIN is not almost generated.

Although the present invention was described in detail with reference to the above examples, this invention is not limited to the above disclosure and every kind of variation and modification may be made without departing from the scope of the present invention.

What is claimed is:

1. A magneto-resistance effect element, comprising:
a magneto-resistance effect film including a free magnetization layer with a first magnetic film of which a magnetization is changed in accordance with an external magnetic field, a fixed magnetization layer with a second magnetic film of which a magnetization is fixed in one direction and an intermediate layer disposed between said free magnetization layer and said fixed magnetization layer;
a magnetic coupling layer which is disposed on one surface of said fixed magnetization layer opposite to the other surface of said fixed magnetization layer adjacent to said intermediate layer;
a ferromagnetic layer which is disposed on one surface of said magnetic coupling layer opposite to the other surface of said magnetic coupling layer adjacent to said fixed magnetization layer;
an antiferromagnetic layer which is disposed on one surface of said ferromagnetic layer opposite to the other surface of said ferromagnetic layer adjacent to said magnetic coupling layer;
a magnetic domain controlling film for applying a biasing magnetic field to said free magnetization layer so that a direction of said biasing magnetic field can be parallel to a film surface of said magneto-resistance effect film and perpendicular to a magnetization direction of said fixed magnetization layer; and
a pair of electrodes for flowing a current in said magneto-resistance effect film along a direction from said free magnetization layer to said fixed magnetization layer;
wherein an asymmetry is set positive;
wherein an element resistance RA in said direction is set to 1.5 Ωμm² or less.

2. The element as set forth in claim 1,
wherein in said magneto-resistance effect film, an interlayer coupling magnetic field between said fixed magnetization layer and said free magnetization layer is set within a range of 30 to 100 Oe.

3. The element as set forth in claim 1,
wherein a medium signal reproducing efficiency of said element is set less than 15%.

4. The element as set forth in claim 1,
wherein a thickness of said intermediate layer is set within a range of 0.4 to 1.1 nm;
wherein said intermediate layer is made of an oxide with conductors electrically connected with said free magnetization layer and said fixed magnetization layer throughout said oxide.

5. The element as set forth in claim 1,
wherein a thickness of said intermediate layer is set within a range of 0.4 to 1.1 nm;
wherein said intermediate layer is made of an insulator.

6. The element as set forth in claim 1,
wherein a distance between said free magnetization layer and said magnetic domain controlling film is set to 5 nm or less.

7. A magnetic head comprising a magneto-resistance effect element as set forth in claim 1.

8. A magnetic recording/reproducing device comprising a magnetic recording medium and a magnetic head as set forth in claim 7.
